(19) United States
(12) Patent Application Publication
(10) Pub. No.: US 2014/0324535 A1
(43) Pub. Date: Oct. 30, 2014

(54) POWER INFRASTRUCTURE SIZING AND WORKLOAD MANAGEMENT

(71) Applicant: HEWLETT-PACKARD DEVELOPMENT COMPANY, L.P., Houston, TX (US)

(72) Inventors: Yuan CHEN, Sunnyvale, CA (US); Zhenhua Liu, Pasadena, CA (US); Cullen E. Bash, Los Gatos, CA (US)

(73) Assignee: Hewlett-Packard Development Company, L.P., Houston, TX (US)

(21) Appl. No.: 13/874,272

(22) Filed: Apr. 30, 2013

(51) Int. Cl. G06Q 30/02

(52) U.S. Cl. CPC G06Q 30/0202
USPC 705/7.31

(57) ABSTRACT

According to an example, power infrastructure sizing and workload management of an entity may include receiving power supply and information technology (IT) workload demand input parameter specifications for the entity, and using the power supply and IT workload demand input parameter specifications for a power infrastructure sizing and workload management model for the entity. The power infrastructure sizing and workload management model may be used to generate power supply and IT workload demand output parameter specifications for the entity.

### BACKGROUND

Entities such as data centers are typically used to house computer systems and associated components, such as telecommunications and storage systems. Such entities also typically include redundant or backup power supplies, redundant data communications connections, environmental controls (e.g., air conditioning, fire suppression, etc.) and security devices. The implementation and operation of such components factor into aspects such as capital and operational expenditures associated with an entity. Further, the implementation and operation of such components factor into the carbon footprint associated with an entity.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a power infrastructure sizing and workload management apparatus, according to an example of the present disclosure;

FIG. 2 illustrates parameters of a power infrastructure sizing and workload management model, according to an example of the present disclosure;

FIG. 3 illustrates a method for power infrastructure sizing and workload management of an entity, according to an example of the present disclosure; and

FIG. 4 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Entities such as data centers, buildings, electronics cabinets, etc., typically implement and operate components so as to reduce energy usage and the associated carbon footprint. For example, an entity may use renewable on-site power supplies and alternative cooling approaches to reduce energy usage and the associated carbon footprint. While such solutions may provide significant environmental benefits, the high costs associated with such solutions often limit their adaption in practice. In this regard, the high costs may be reduced by more effective usage of such renewable resources during the operation of entities. The high costs may also be reduced by optimizing the design and operation of entities to minimize the total cost across the entity lifecycle. For example, the high costs may be reduced by determining the appropriate mix and size of renewable power sources to minimize the capital expense, and optimizing IT workload management combined with energy supply provisioning to minimize operational energy cost.

According to an example, a power infrastructure sizing and workload management apparatus, and a method for power infrastructure sizing and workload management of an entity are disclosed herein. The apparatus and method disclosed herein may be implemented to minimize energy costs of entities, including capital and operational costs, by integrating energy supply provisioning with information technology (IT) workload demand management across the entity lifecycle. The apparatus and method disclosed herein may provide for the design and operation of an entity consuming net-zero energy from a grid over the lifetime of the entity at a minimal cost.

The apparatus and method disclosed herein may integrate the management of power supply and demand for an entity to minimize the lifetime cost, while maintaining the environmental impact target of an entity. For example, the apparatus and method disclosed herein may determine the optimal mix and size of power sources to minimize capital cost. Further, the apparatus and method disclosed herein may schedule IT workloads based on power supply availability to minimize operational cost. By using local renewable generation and optimizing the power micro-grid with demand management, the apparatus and method disclosed herein may provide for the design and operation of entities using renewable energy while minimizing total cost.

The apparatus and method disclosed herein may provide for integrated optimization of power infrastructure sizing and workload management from design to operation. The total lifetime energy cost of an entity, including capital expenditures and operational expenditures, may be reduced, while maintaining the environmental impact target of an entity. In addition, entities may be designed and operated to consume net-zero energy from a grid over the entity lifetime at a minimal cost.

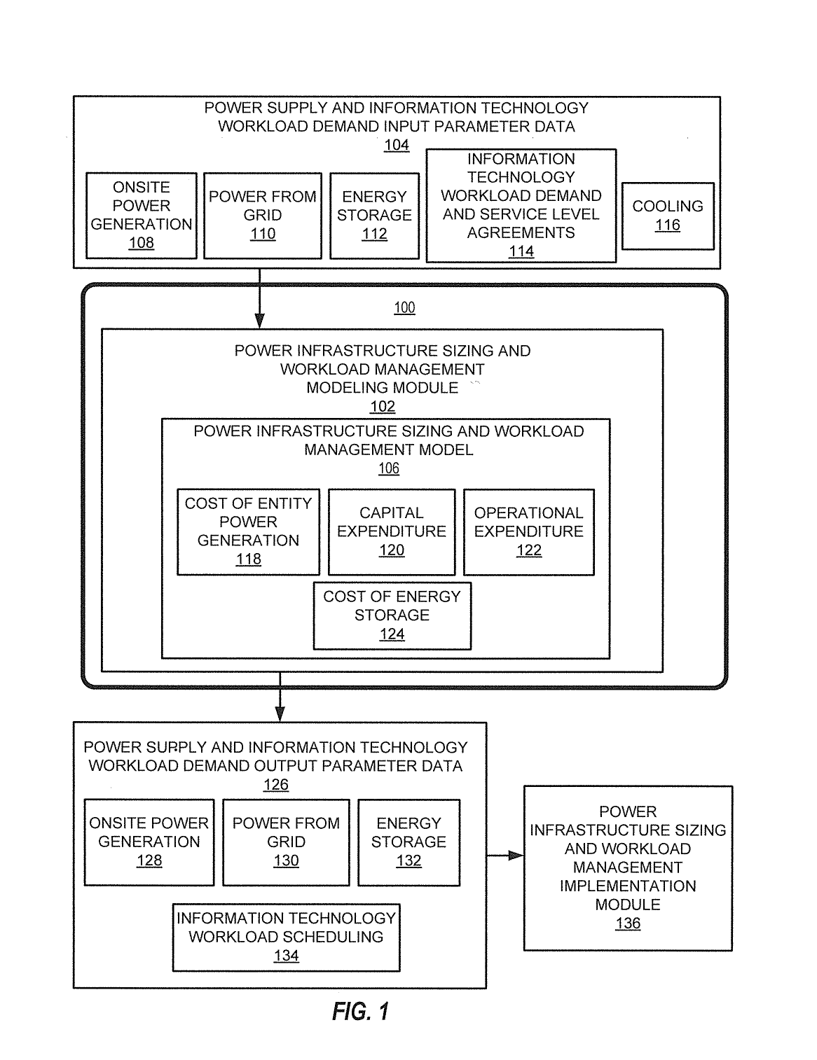

FIG. 1 illustrates an architecture of a power infrastructure sizing and workload management apparatus 100, according to an example. The apparatus 100 may be used for power infrastructure sizing and workload management of an entity, such as a data center, building, electronics cabinet, etc. Referring to FIG. 1, the apparatus 100 is depicted as including a power infrastructure sizing and workload management modeling module 102 to receive power supply and information technology (IT) workload demand input parameter specifications 104 (hereinafter “input parameter specifications 104”) for an entity. The power infrastructure sizing and workload management modeling module 102 may utilize the input parameter specifications 104 for a power infrastructure sizing and workload management model 106. The input parameter specifications 104 may include specifications for parameters related to onsite power generation 108, power from grid 110, energy storage 112, IT workload demand and service-level agreements (SLAs) 114, and cooling 116.

The power infrastructure sizing and workload management model 106 may be used to determine the optimal mix and size of power sources to minimize capital cost for an entity, and schedule IT workloads based on supply availability to minimize operational cost for the entity. The power infrastructure sizing and workload management model 106 may use the input parameter specifications 104 to evaluate cost of entity power generation at 118, entity capital expenditure at 120, entity operational expenditure at 122, and cost of energy storage at 124. The power infrastructure sizing and workload management model 106 may be used to generate power supply and IT workload demand output parameter specifications 126 (hereinafter “output parameter specifications 126”) for the entity. The output parameter specifications 126 may include data for parameters related to onsite power generation 128, power from grid 130, energy storage 132, and IT workload scheduling 134. A power infrastructure sizing and workload management implementation module 136 may receive the output parameter specifications 126 to implement the optimal mix and size of power sources to minimize capital cost, and schedule IT workloads based on supply availability to minimize operational cost. The power infrastructure sizing and workload management implementation module 136 may be provided as a component of the apparatus 100 or separately from the apparatus 100 to implement the output parameter specifications 126.

The modules 102 and 136, and other components of the apparatus 100 that perform various other functions in the apparatus 100, may include machine readable instructions stored on a non-transitory computer readable medium. In addition, or alternatively, the modules 102 and 136, and other components of the apparatus 100, may include hardware or a combination of machine readable instructions and hardware.

The power infrastructure sizing and workload management apparatus 100 may generally provide for integration of the management of resource supply and demand for an entity to deliver sustainable entities. The apparatus 100 may generally integrate the management of power supply and demand for an entity in order to minimize the lifetime cost of the entity, while maintaining the environmental impact target of the entity. This may be accomplished by optimizing the power infrastructure size and managing IT workloads based on resource availability. The apparatus 100 may provide for the proper design and correct provisioning of the power supply infrastructure to minimize the capital cost, while providing sufficient renewable resources to meet the carbon footprint target of an entity. Further, the apparatus 100 may provide for balancing of the entity workload, and thus operational energy demand within given supply-side constraints to minimize the operational cost of an entity. In this regard, the power infrastructure sizing and workload management model 106 may characterize the power supply and demand of an entity and generate a general capacity management solution that integrates supply-aware workload planning with supply-side sizing to optimize the power supply infrastructure and workload management from design to operation.

In order to integrate power supply sizing and IT workload capacity planning, the power infrastructure sizing and workload management modeling module 102 may receive the power supply and IT workload demand input parameter specifications 104. The input parameter specifications 104 may include specifications for parameters related to onsite power generation 108, power from grid 110, energy storage 112, IT workload demand and SLAs 114, and cooling 116. The input parameter specifications 104 may generally account for energy supply options and related parameters, location specific environmental data, IT workload demand, and operational goals. For example, the input parameter specifications 104 may be based on receipt of power source options and costs (e.g., electricity price, renewable supplies), energy storage parameters, environmental data (e.g., weather data), IT workload and SLAs, and operational goals (e.g., carbon emission reduction target for an entity).

The power infrastructure sizing and workload management modeling module 102 may utilize the input parameter specifications 104 for the power infrastructure sizing and workload management model 106 that generates, for example, an optimal mix and size of power sources, a detailed power generation and consumption profile, a cost report, and a workload scheduling plan. For example, the optimal mix and size of power sources may provide optimal power infrastructure sizes. The detailed power generation and consumption profile may provide, for example, projections for energy consumption, and energy supply. The detailed cost report and comparison of different solutions may provide, for example, a total cost breakdown (e.g., capital expenditures and operational expenditures), carbon footprint for an entity, and payback period. Further, the workload scheduling plan may provide, for example, a detailed IT workload and capacity allocation plan.

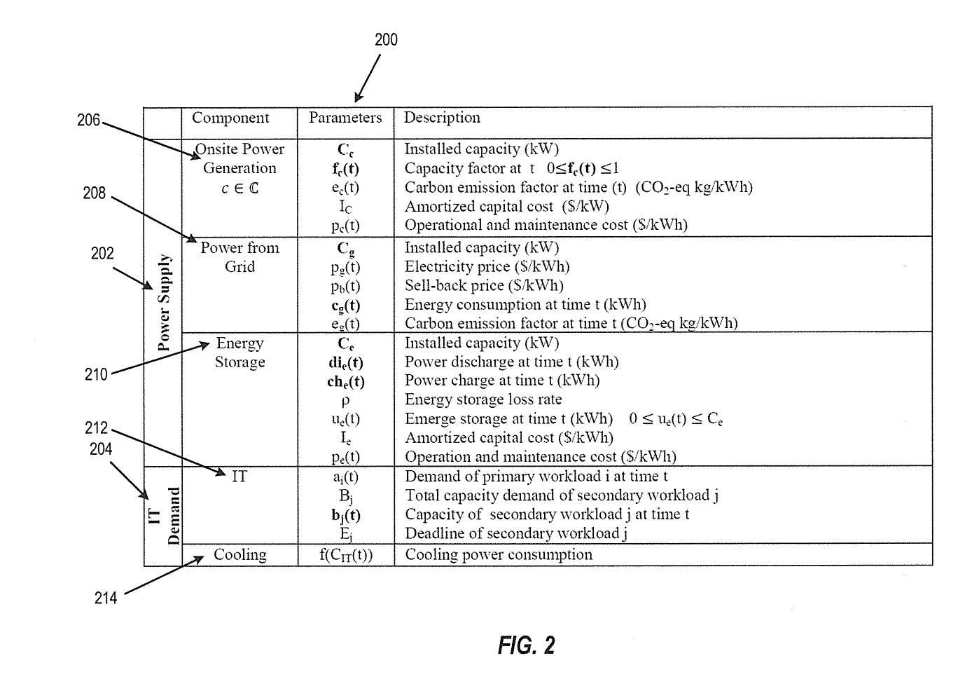

Referring to FIGS. 1 and 2, FIG. 2 illustrates parameters 200 of the power infrastructure sizing and workload management model 106, according to an example of the present disclosure. In order to implement the power infrastructure sizing and workload management model 106, the power infrastructure sizing and workload management modeling module 102 may receive the power supply and IT workload demand input parameter specifications 104. The parameters 200 may be partitioned as power supply parameters shown in FIG. 2 at 202, and IT demand (i.e., IT workload demand) input parameters at 204. The power supply and IT workload demand input parameter specifications 104 (i.e., power supply parameters at 202, and IT demand parameters at 204) may be respectively characterized as energy infrastructure parameters and energy demand parameters.

With respect to the power supply parameters at 202, the power infrastructure sizing and workload management model 106 may consider two categories of power generation options, that is, onsite power generation at 206 and power from the grid at 208. Onsite power generation at 206 may include renewable or non-renewable power generated by an entity's own facilities. For example, the onsite power generation at 206 may include parameter C_{c} that may represent installed capacity of onsite power generation including units of kW (e.g., 500 kW of solar power), parameter f_{c}(t) that may represent a capacity factor of onsite power generation at time t, where 0≦f_{c}(t)≦1, parameter e_{c}(t) that may represent a carbon emission factor of onsite power generation at time t including units of CO₂-eq kg/kWh, parameter I_{c} that may represent an amortized capital cost of onsite power generation including units of $/kW, and parameter p_{c}(t) that may represent operational and maintenance cost of onsite power generation including units of $/kWh. The parameters e_{c}(t), I_{C}, and p_{c}(t) may represent input parameters that receive the input parameter specifications 104 for the power infrastructure sizing and workload management model 106, and the parameters C_{c} and f_{c}(t) may represent output parameters that generate output parameter specifications 126 using the power infrastructure sizing and workload management model 106.

Power from the grid at 208 may include, for example, electricity from traditional power plants and renewable energy sources. For example, the power from the grid at 208 may include parameter C_{g} that may represent an installed capacity of power from the grid including units of kW, parameter p_{g}(t) that may represent an electricity price of power from the grid at time t including units of $/kWh, parameter p_{b}(t) that may represent a sell-back price of power from the grid at time t including units of $/kWh, parameter c_{g}(t) that may represent an energy consumption of power from the grid at time t including units of kWh, and parameter e_{g}(t) that may represent a carbon emission factor of power from the grid at time t including units of CO₂-eq kg/kWh. The parameters p_{g}(t), p_{b}(t), and e_{g}(t) may represent input parameters that receive the input parameter specifications 104 for the power infrastructure sizing and workload management model 106, and the parameters C_{g} and c_{g}(t) may represent output parameters that generate output parameter specifications 126 using the power infrastructure sizing and workload management model 106.

The power supply parameters at 202 may further include parameters related to energy storage devices at 210. For example, the energy storage devices at 210 may include parameter Cₑ that may represent an installed capacity of energy storage including units of kW, parameter diₑ(t) that may represent a power discharge of energy storage at time t including units of kWh, parameter chₑ(t) that may represent a power charge of energy storage at time t including units of kWh, parameter ρ that may represent an energy storage loss rate, parameter uₑ(t) that may represent an emerge storage at time t including units of kWh, where 0≦uₑ(t)≦Cₑ, parameter Iₑ that may represent an amortized capital cost of energy storage including units of $/kWh, and parameter pₑ(t) may represent operational and maintenance cost of energy storage at time t including units of $/kWh. The parameters ρ, uₑ(t), Iₑ, and pₑ(t) may represent input parameters that receive the input parameter specifications 104 for the power infrastructure sizing and workload management model 106, and the parameters Cₑ, diₑ(t), and chₑ(t) may represent output parameters that generate output parameter specifications 126 using the power infrastructure sizing and workload management model 106.

With respect to the IT workload demand input parameters at 204, the power infrastructure sizing and workload management model 106 may consider that entities generally support a range of IT workloads (i.e., at 212), including both primary interactive applications that may run 24 hrs/day and 7 days/week (e.g., Internet services), and non-interactive, delay tolerant, batch-style applications (e.g., scientific applications, financial analysis, and image processing), which may be referred to as secondary workloads. Thus, primary workloads may be defined by their IT demand, and the secondary workloads may be defined in terms of IT demand and completion time. Generally, secondary workloads may be scheduled to run anytime as long as such workloads finish before their deadlines. These aspects may provide flexibility for workload management.

The IT workloads at 212 may include parameter aᵢ(t) that may represent a demand of primary workload i at time t, parameter Bⱼ that may represent a total capacity demand of secondary workload j, parameter bⱼ(t) that may represent a capacity of secondary workload j at time t, and parameter Eⱼ that may represent a capacity of secondary workload j at time t. The parameters aᵢ(t), Bⱼ, and Eⱼ may represent input parameters that receive the input parameter specifications 104 for the power infrastructure sizing and workload management model 106, and the parameter bⱼ(t) may represent an output parameter that generates output parameter specifications 126 using the power infrastructure sizing and workload management model 106.

With respect to the IT workload demand input parameters at 204, cooling power demand at 214 may be derived from IT power demand, e.g., via power usage effectiveness (PUE). IT power demand may include demand from both primary and secondary workloads, i.e., C_{IT}(t)=Σᵢaᵢ(t)+Σⱼbⱼ(t), where a and b respectively represent primary and secondary workloads. The cooling power demand at 214 may include parameter f(C_{IT}(t)) that may represent cooling power consumption at time t. The parameter f(C_{IT}(t)) may represent an input parameter that receives the input parameter specifications 104 for the power infrastructure sizing and workload management model 106.

The power infrastructure sizing and workload management model 106 may optimize the power supply infrastructure size and operation to minimize the total entity cost while meeting specified operational goals by formulating the power supply parameters at 202 and the IT workload demand parameters at 204 as a constrained optimization model. For example, the power infrastructure sizing and workload management model 106 may optimize the power supply infrastructure size and operation as follows:

$$\begin{matrix}{Min}_{{C}_{c} , {f}_{c} , {C}_{g} , {C}_{g} , {C}_{e} , {di}_{e} , {ch}_{e} , {b}_{j}} {\sum }_{c} ( {I}_{c} {C}_{c} + {\sum }_{t} {p}_{c} ( t ) {C}_{c} {f}_{c} ( t ) ) + {I}_{g} {C}_{g} + {\sum }_{t} ( {p}_{g} ( t ) {{c}_{g} ( t )}^{+} + {p}_{b} ( t ) {{c}_{g} ( t )}^{-} ) + {I}_{e} {C}_{e} + {\sum }_{t} ( {p}_{e} ( t ) {di}_{e} ( t ) ) & Equation ( 1 ) \\ {\sum }_{i} {a}_{i} ( t ) + {\sum }_{j} {b}_{j} ( t ) + f ( {C}_{IT} ) \leq {\sum }_{c} {C}_{c} {f}_{c} ( t ) + {c}_{g} ( t ) + {di}_{e} ( t ) / ρ - {ch}_{e} ( t ) {∀}_{t} & Equation ( 2 ) \\ {\sum }_{c} ( {\sum }_{t} {e}_{c} ( t ) {C}_{c} {f}_{c} ( t ) ) + {\sum }_{t} {c}_{g} ( t ) {e}_{g} ( t ) \leq CG {∀}_{t} & Equation ( 3 ) \\ 0 \leq {f}_{c} ( t ) \leq 1 {∀}_{t} , {∀}_{c} & Equation ( 4 ) \\ - {C}_{g} \leq {c}_{g} ( t ) \leq {C}_{g} {∀}_{t} & Equation ( 5 ) \\ 0 \leq {u}_{e} ( t ) \leq {C}_{e} , {u}_{e} ( t + 1 ) = {u}_{e} ( t ) - \frac{{di}_{e} ( t )}{ρ} + {ch}_{e} ( t ) {∀}_{t} & Equation ( 6 ) \\ {\sum }_{t} {b}_{j} ( t ) \leq {B}_{j} {∀}_{j} & Equation ( 7 )\end{matrix}$$

With respect to Equations (1)-(7), each of the parameters are listed and described in FIG. 2. Further, for Equation (1), I_{g} may represent the amortized capital cost in $/kW of the entity infrastructure for power from the grid, and for Equation (3), CG may represent a carbon emission objective. With respect to Equations (1)-(7), as shown for Equation (1), the power infrastructure sizing and workload management model 106 may optimize the power supply infrastructure size and operation by minimizing the output parameters C_{c}, f_{c}(t), C_{g}, c_{g}(t), Cₑ, diₑ(t), chₑ(t), and bⱼ(t). Specifically, the power infrastructure sizing and workload management model 106 may minimize the total cost, including the capital and operational expenditures of the power infrastructure. Referring to FIG. 1 and Equation (1), the first term may represent the cost of entity power generation 118. The second and third terms of Equation (1) may respectively define the capital and operational expenditures of the power grid at 120, 122, respectively. The fourth and fifth terms of Equation (1) may specify the costs of energy storage at 124. With respect to Equation (2), Equation (2) may represent a constraint that states that the total power consumption from IT and cooling should not exceed the total power supply to the entity. Equation (3) may represent a constraint that specifies that the total emissions are equal to or less than the carbon emission goal of the entity. The capacity of each onsite power generator and the grid power may be represented by Equations (4) and (5), respectively. Equation (6) may represent the energy storage model for the entity. Equation (7) may represent the workload constraint for the entity, and may be set to equality for all secondary workload demand to be satisfied. The power infrastructure sizing and workload management model 106 may accept additional constraints, such as a carbon footprint target, as needed. The optimization provided by the power infrastructure sizing and workload management model 106 may be considered jointly convex in C_{c}, f_{c}(t), C_{g}, c_{g}(t), Cₑ, diₑ(t), chₑ(t), and bⱼ(t), and hence may be efficiently solved.

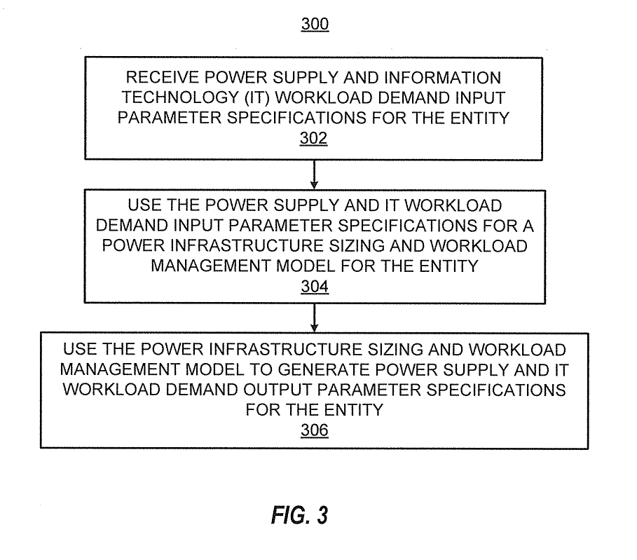

FIG. 3 illustrates a flowchart of a method 300 for power infrastructure sizing and workload management of an entity, corresponding to the example of the power infrastructure sizing and workload management apparatus 100 whose construction is described in detail above. The method 300 may be implemented on the power infrastructure sizing and workload management apparatus 100 with reference to FIG. 1 by way of example and not limitation. The method 300 may be practiced in other apparatus.

Referring to FIG. 3, for the method 300, at block 302, power supply and IT workload demand input parameter specifications for an entity may be received. For example, referring to FIG. 1, the power infrastructure sizing and workload management modeling module 102 may receive power supply and IT workload demand input parameter specifications 104 for an entity.

At block 304, the power supply and IT workload demand input parameter specifications may be used for a power infrastructure sizing and workload management model for the entity. For example, referring to FIG. 1, the power infrastructure sizing and workload management modeling module 102 may utilize the input parameter specifications 104 for the power infrastructure sizing and workload management model 106.

At block 306, the power infrastructure sizing and workload management model may be used to generate power supply and IT workload demand output parameter specifications for the entity to provide optimal power infrastructure sizing for the entity to minimize capital cost of the entity, and IT workload management to minimize operational cost of the entity. For example, referring to FIG. 1, the power infrastructure sizing and workload management model 106 may be used to generate power supply and IT workload demand output parameter specifications 126 for the entity.

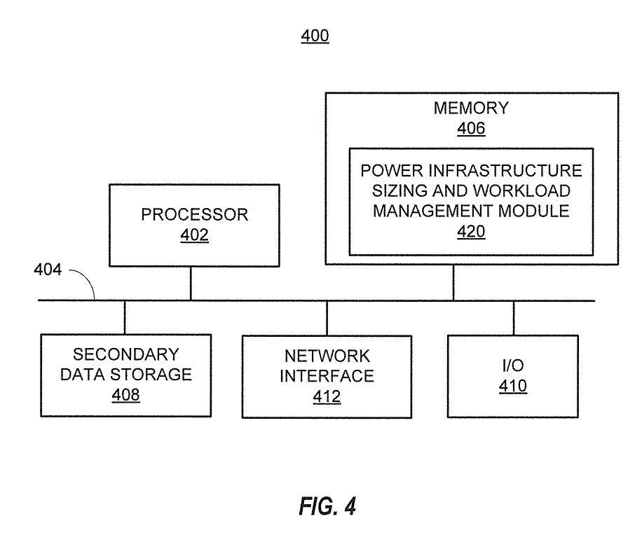

FIG. 4 shows a computer system 400 that may be used with the examples described herein. The computer system represents a generic platform that includes components that may be in a server or another computer system. The computer system 400 may be used as a platform for the apparatus 100. The computer system 400 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums. The memory 406 may include a power infrastructure sizing and workload management module 420 including machine readable instructions residing in the memory 406 during runtime and executed by the processor 402. The power infrastructure sizing and workload management module 420 may include the modules 102 and 136 of the apparatus shown in FIG. 1.

The computer system 400 may include an I/O device 410, such as a keyboard, a mouse, a display, etc. The computer system may include a network interface 412 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for power infrastructure sizing and workload management of an entity, the method comprising:
receiving power supply and information technology (IT) workload demand input parameter specifications for the entity;
using the power supply and IT workload demand input parameter specifications for a power infrastructure sizing and workload management model for the entity; and
using, by a processor, the power infrastructure sizing and workload management model to generate power supply and IT workload demand output parameter specifications for the entity.

2. The method of claim 1, wherein receiving power supply and IT workload demand input parameter specifications for the entity further comprises:
receiving the power supply and IT workload demand input parameter specifications for parameters related to onsite power generation, power from grid, energy storage, IT workload demand and service-level agreements (SLAs), and cooling.

3. The method of claim 1, wherein to generate power supply and IT workload demand output parameter specifications for the entity further comprises:
generating the power supply and IT workload demand output parameter specifications for parameters related to onsite power generation, power from grid, energy storage, and IT workload scheduling.

4. The method of claim 1, wherein:
receiving power supply and IT workload demand input parameter specifications for the entity further comprises:
receiving the power supply and IT workload demand input parameter specifications for a parameter e_{c}(t) that represents a carbon emission factor of onsite power generation at time t, a parameter I_{C} that represents an amortized capital cost of the onsite power generation, and a parameter p_{c}(t) that represents operational and maintenance cost of the onsite power generation at time t; and
using the power infrastructure sizing and workload management model to generate power supply and IT workload demand output parameter specifications for the entity further comprises:
using the power infrastructure sizing and workload management model to generate the power supply and IT workload demand output parameter specifications for a parameter C_{c} that represents installed capacity of the onsite power generation, and a parameter f_{c}(t) that represents a capacity factor of onsite power generation at time t, where 0≦f_{c}(t)≦1.

5. The method of claim 1, wherein:
receiving power supply and IT workload demand input parameter specifications for the entity further comprises:
receiving the power supply and IT workload demand input parameter specifications for a parameter p_{g}(t) that represents an electricity price of power from a grid at time t, a parameter p_{b}(t) that represents a sell-back price of power from the grid at time t, and a parameter e_{g}(t) that represents a carbon emission factor of power from the grid at time t; and
using the power infrastructure sizing and workload management model to generate power supply and IT workload demand output parameter specifications for the entity further comprises:
using the power infrastructure sizing and workload management model to generate the power supply and IT workload demand output parameter specifications for a parameter C_{g} that represents an installed capacity of power from the grid, and a parameter c_{g}(t) that represents an energy consumption of power from the grid at time t.

6. The method of claim 1, wherein:
receiving power supply and IT workload demand input parameter specifications for the entity further comprises:
receiving the power supply and IT workload demand input parameter specifications for a parameter ρ p that represents an energy storage loss rate, a parameter uₑ(t) that represents an emerge storage at time t, where 0≦uₑ(t)≦Cₑ, and parameter Cₑ represents an installed capacity of energy storage, a parameter Iₑ that represents an amortized capital cost of energy storage, and a parameter pₑ(t) that represents operation and maintenance cost of energy storage at time t; and
using the power infrastructure sizing and workload management model to generate power supply and IT workload demand output parameter specifications for the entity further comprises:
using the power infrastructure sizing and workload management model is to generate the power supply and IT workload demand output parameter specifications for the parameter Cₑ that represents the installed capacity of energy storage, a parameter diₑ(t) that represents a power discharge of energy storage at time t, and a parameter chₑ(t) that represents a power charge of energy storage at time t.

7. The method of claim 1, wherein:
receiving power supply and IT workload demand input parameter specifications for the entity further comprises:
receiving the power supply and IT workload demand input parameter specifications for a parameter aᵢ(t) that represents a demand of primary workload i at time t, a parameter Bⱼ that represents a total capacity demand of secondary workload j, and a parameter Eⱼ that represents a capacity of the secondary workload j at time t, wherein a primary workload is defined based on IT demand, and a secondary workload is defined based on IT demand and completion time such that the secondary workload is executable at any time to meet the completion time; and
using the power infrastructure sizing and workload management model to generate the power supply and IT workload demand output parameter specifications for the entity further comprises:
using the power infrastructure sizing and workload management model to generate the power supply and IT workload demand output parameter specifications for a parameter bⱼ(t) that represents a capacity of the secondary workload j at time t.

8. The method of claim 1, wherein using the power infrastructure sizing and workload management model to generate power supply and IT workload demand output parameter specifications for the entity further comprises:
minimizing parameters C_{c}, f_{c}(t), C_{g}, c_{g}(t), Cₑ, diₑ(t), chₑ(t), and bⱼ(t) for the equation:
$${Min}_{{C}_{c} , {f}_{c} , {C}_{g} , {C}_{g} , {C}_{e} , {di}_{e} , {ch}_{e} , {b}_{j}} {\sum }_{c} ( {I}_{c} {C}_{c} + {\sum }_{t} {p}_{c} ( t ) {C}_{c} {f}_{c} ( t ) ) + {I}_{g} {C}_{g} + {\sum }_{t} ( {p}_{g} ( t ) {{c}_{g} ( t )}^{+} + {p}_{b} ( t ) {{c}_{g} ( t )}^{-} ) + {I}_{e} {C}_{e} + {\sum }_{t} ( {p}_{e} ( t ) {di}_{e} ( t ) )$$
wherein for the parameters C_{c}, f_{c}(t), C_{g}, c_{g}(t), Cₑ, diₑ(t), chₑ(t), and bⱼ(t), parameter C_{c} represents installed capacity of the onsite power generation, parameter f_{c}(t) represents a capacity factor of onsite power generation at time t, where 0≦f_{c}(t)≦1, parameter C_{g} represents an installed capacity of power from a grid, parameter c_{g}(t) represents an energy consumption of power from the grid at time t, parameter Cₑ represents installed capacity of energy storage, parameter diₑ(t) represents a power discharge of energy storage at time t, parameter chₑ(t) represents a power charge of energy storage at time t, and parameter bⱼ(t) represents a capacity of a secondary workload j at time t, and
wherein for the parameters I_{C}, p_{c}(t), I_{g}, p_{g}(t), p_{b}(t), Iₑ, and pₑ(t), parameter I_{C} represents an amortized capital cost of the onsite power generation, parameter p_{c}(t) represents operational and maintenance cost of the onsite power generation at time t, parameter I_{g} represents an amortized capital cost of grid power supply, parameter p_{g}(t) represents an electricity price of power from the grid at time t, parameter p_{b}(t) represents a sell-back price of power from the grid at time t, parameter Iₑ represents an amortized capital cost of energy storage, and parameter pₑ(t) represents operation and maintenance cost of energy storage at time t.

9. The method of claim 8, further comprising:
evaluating the equation based on the constraint:
Σᵢaᵢ(t)+Σⱼbⱼ(t)+f(C_{IT})≦Σ_{c}C_{c}f_{c}(t)+c_{g}(t)+diₑ(t)/ρ−chₑ(t) ∀ₜ,
wherein for the parameters aᵢ(t), f(C_{IT}(t)), and ρ, parameter aᵢ(t) represents a demand of primary workload i at time t, parameter f(C_{IT}(t)) represents cooling power consumption at time t, and parameter ρ represents an energy storage loss rate.

10. The method of claim 8, further comprising:
is evaluating the equation based on the constraint:
Σ_{c}(Σₜe_{c}(t)C_{c}f_{c}(t))+Σₜc_{g}(t)e_{g}(t)≦CG ∀ₜ,
wherein for the parameters e_{c}(t), e_{g}(t), and CG, parameter e_{c}(t) represents a carbon emission factor of onsite power generation at time t, parameter e_{g}(t) represents a carbon emission factor of power from the grid at time t, and parameter CG represents a carbon emission objective.

11. The method of claim 8, further comprising:
evaluating the equation based on the constraint:
−C_{g}≦c_{g}(t)≦C_{g} ∀ₜ,
wherein the parameter C_{g} represents an installed capacity of power from the grid.

12. The method of claim 8, further comprising:
evaluating the equation based on the constraint:
$$0 \leq {u}_{e} ( t ) \leq {C}_{e} , {u}_{e} ( t + 1 ) = {u}_{e} ( t ) - \frac{{di}_{e} ( t )}{ρ} + {ch}_{e} ( t ) {∀}_{t} ,$$
wherein for the parameters uₑ(t), Cₑ, and ρ, parameter uₑ(t) represents an emerge storage at time t, parameter Cₑ represents an installed capacity of energy storage, and parameter ρ represents an energy storage loss rate.

13. The method of claim 8, further comprising:
evaluating the equation based on the constraint:
Σₜbⱼ(t)≦Bⱼ ∀ⱼ,
wherein the parameter Bj represents a total capacity demand of secondary workload j.

14. A power infrastructure sizing and workload management apparatus comprising:
a memory storing machine readable instructions to:
receive power supply and information technology (IT) workload demand input parameter specifications for an entity for parameters related to onsite power generation, power from grid, energy storage, IT workload demand and service-level agreements (SLAs), and cooling;
use the power supply and IT workload demand input parameter specifications for a power infrastructure sizing and workload management model for the entity; and
use the power infrastructure sizing and workload management model to generate power supply and IT workload demand output parameter specifications for the entity to provide:
optimal power infrastructure sizing for the entity to minimize capital cost of the entity, and
IT workload management to minimize operational cost of the entity; and
a processor to implement the machine readable instructions.

15. A non-transitory computer readable medium having stored thereon machine readable instructions to provide power infrastructure sizing and workload management, the machine readable instructions, when executed, cause a computer system to:
receive power supply and information technology (IT) workload demand input parameter specifications for an entity;
use the power supply and IT workload demand input parameter specifications for a power infrastructure sizing and workload management model for the entity; and
use, by a processor, the power infrastructure sizing and workload management model to generate power supply and IT workload demand output parameter specifications for the entity for parameters related to onsite power generation, power from grid, energy storage, and IT workload scheduling, to provide:
optimal power infrastructure sizing for the entity to minimize capital cost of the entity, and
IT workload management to minimize operational cost of the entity.
